(19) United States
(12) Patent Application Publication
(10) Pub. No.: US 2007/0137022 A1
(43) Pub. Date: Jun. 21, 2007

(54) FLANGE FOR VEHICLE EXHAUST SYSTEM

(75) Inventor: Michael A. Haller, Laval, QC (CA)

Correspondence Address: FAY SHARPE LLP, 1100 SUPERIOR AVENUE, SEVENTH FLOOR, CLEVELAND, OH, 44114, US

(73) Assignee: ROL MANUFACTURING (CANADA) LTD., Laval (CA)

(21) Appl. No.: 11/614,029

(22) Filed: Dec. 20, 2006

Related U.S. Application Data
(60) Provisional application No. 60/752,491, filed on Dec. 21, 2005.

(51) Int. Cl. B23P 13/04

(52) U.S. Cl. 29/557

(57) ABSTRACT

A flange for a vehicle exhaust system includes a central opening, bolt holes spaced from the central opening, an annular groove spaced from the central opening formed in a first surface of the flange, and an annular protrusion spaced from the central opening formed in a second surface of the flange. The annular groove and the annular protrusion generally have the same configuration taken in a radial cross-section of each. A method of manufacturing a flange for a vehicle exhaust system includes the following steps: forming or cutting a blank part having a desired peripheral configuration; forming or cutting a plurality of bolt holes in the part; piercing a central opening in the part, wherein the central opening is radially inwardly spaced from the bolt holes; displacing metal in a first surface of the part to form an annular groove that is radially spaced from the central opening, wherein the material that is displaced from the annular groove is allowed to protrude from a second surface of the flange to form an annular protrusion.

This application claims the benefit of U.S. Application No. 60/752,491, filed Dec. 21, 2005, which is incorporated by reference herein.

### BACKGROUND

Flanges are used to connect components of automobile exhaust systems. An example is shown in FIG. 1, which shows flanges 10 used to connect exhaust pipes 12. A gasket 14 can also be used with the assembly. Bolts 16 and nuts 18, which are known in the art, cooperate to fasten the pipes 12 to one another. The flanges can be grooved or not include a groove. Also, the flanges can be affixed to exhaust pipes, catalytic converters, muffler assemblies, or the engine exhaust manifold.

With reference to FIG. 2, a known flange 10 includes a plurality of bolt holes 20 (three are shown) equally spaced around the periphery of the flange. The bolt holes 20 are dimensioned to receive bolts to allow the flange 10 to attach to a desired structure (for example as shown in FIG. 1). The flange 10 also includes a central opening 22 that is dimensioned to receive a pipe, for example pipe 12 (FIG. 1). Accordingly, the diameter of the central opening 22 is a function of the pipe that it is configured to receive. As more clearly seen in FIG. 3, the flange 10 includes a first surface 24 and a second surface 28 opposite the first, each of which are preferably substantially planar. An annular groove 26 is cut into the first surface 24 of the flange 10. The annular groove 26 is concentric with the center of the central opening 22 and is rectangular in a radial cross-section.

With this method of manufacturing it is very easy to change the overall groove shape, and concentric can be easily changed to eccentric or noncircular. The groove 26 typically extends less than one-half the thickness of the flange, as seen in FIG. 3. The annular groove is configured to receive a gasket, for example gasket 14 (FIG. 1). The first side 24, the side in which the groove 26 is formed, of the flange 10 typically abuts the structure to which the flange is attached via fasteners. The second side 28 of the flange does not contact other components.

Flanges can take many configurations other than those shown. For example, known flanges may only include two bolt holes and they also have an alternative configuration about the periphery. FIG. 4 depicts a plan view of the second side 28 of the gasket 10. Flanges may also have a construction with multiple exhaust port holes and multiple bolt clamping holes.

Presently, these known flanges are manufactured according to the following method. The outer periphery of the flange is blanked to the desired configuration to form a part and bolt holes 20 are formed in the part. The central opening 22 is then pierced, which results in a blank that looks like the surface shown in plan view in FIG. 4 on both sides of the blank. After the central opening 22 is pierced, the first and second sides of the blank are flattened and the blank is tumbled to remove oil and any burrs.

Flanges can also be cut by compound, or progressive die or cut by plasma, water jet, laser or other two-dimensional cutting means. Photochemical machining, although it would be expensive, can also be used to produce flanges. Flanges can also be cast, or fine blanked or made via powdered metal.

An annular groove 26 that is formed by machining out material from the piece is expensive and slow.

### BRIEF DESCRIPTION OF THE FIGURES

FIG. 1 is an exploded view of a portion of a vehicle exhaust system.

FIG. 2 is a plan view of a first surface of a known flange that can be used with the vehicle exhaust system disclosed in FIG. 1.

FIG. 3 is a cross-sectional view of FIG. 2 taken along line A-A.

FIG. 4 is a plan view of the second surface of the flange depicted in FIG. 2.

FIG. 5 is a plan view of a first surface of a new flange for a vehicle exhaust system.

FIG. 6 is a plan view of a second surface of the flange depicted in FIG. 5.

FIG. 7 is a side elevation view, partially in cross section, of the flange depicted in FIG. 5.

FIG. 8 is a schematic view of a portion of the device used to manufacture the flange depicted in FIGS. 5-7.

### SUMMARY OF THE INVENTION

A flange for a vehicle exhaust system includes a central opening, bolt holes outwardly spaced from the central opening, an annular groove outwardly spaced from the central opening and formed in a first surface of the flange, and an annular protrusion outwardly spaced from the central opening and formed in a second surface of the flange. The annular groove and the annular protrusion generally have the same configuration taken in a radial cross-section.

A method for manufacturing a flange for a vehicle exhaust system includes the following steps: cutting a plurality of bolt holes through a blank metal part; piercing a central opening through the part; and displacing metal from a first surface of the part towards a second surface of the part to form an annular groove that is radially spaced between the plurality of bolt holes and the central opening. The material that is displaced to form the annular groove can protrude from the second surface of the part to form an annular protrusion.

Another example for manufacturing a flange for a vehicle exhaust system includes the following steps: providing an opening in a part; providing a plurality of bolt holes in the part; moving an annular ring into a first surface of the part; and supporting a portion of a second surface of the part with a support surface having an annular channel formed in the support surface.

Flanges made according to the aforementioned methods can form an annular groove in a first surface of the flange without removing material from the flange. Accordingly, if desired there can be no change in mass of the part from before the annular groove is formed into the flange to after the annular groove is formed into the flange.

### DETAILED DESCRIPTION

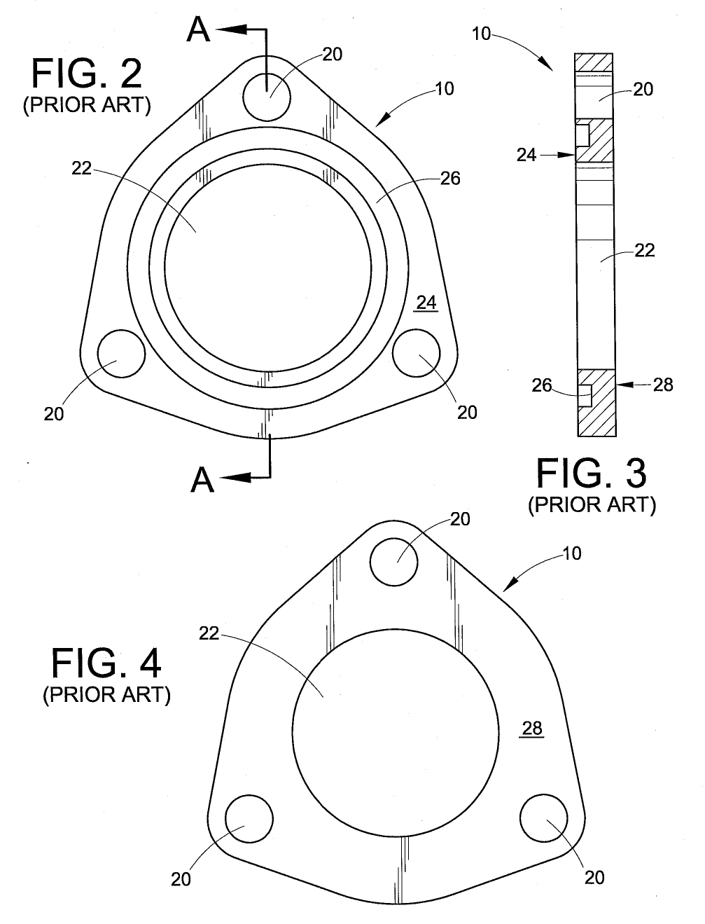

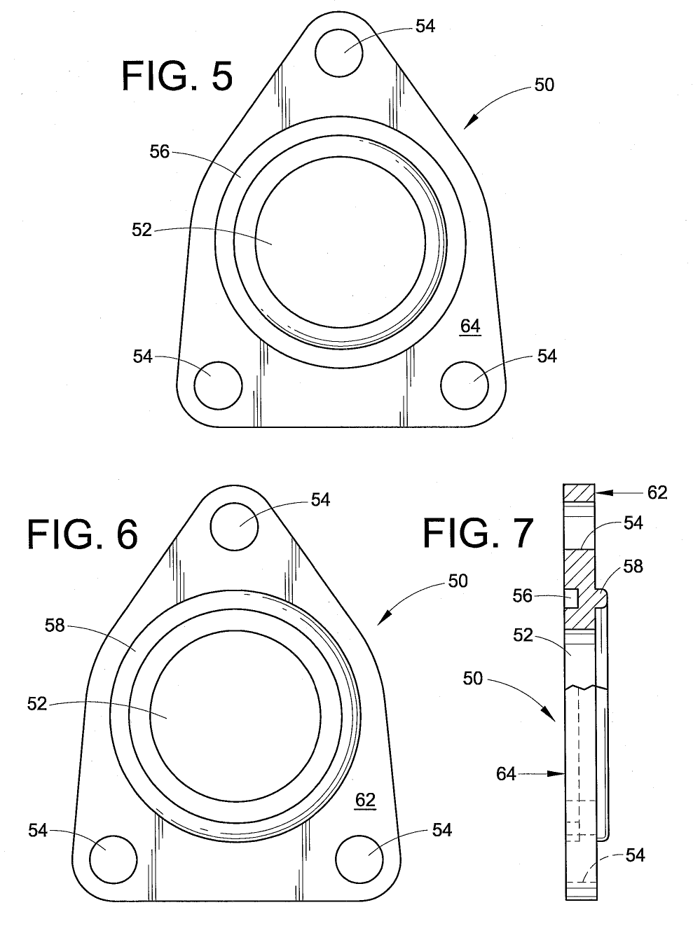

As seen in FIG. 5, a novel flange 50 for use with a vehicle exhaust system includes a central opening 52 and a plurality of bolt holes 54 radially and outwardly spaced from the central opening, which is similar to the flange 10 disclosed in FIGS. 2 and 3. The flange 50 also includes an annular groove 56 that is concentric with the center of the central opening 52 and radially interposed between the central opening 52 and the bolt holes 54. The groove can be square or round in radial cross section. The groove can also be concentric or eccentric annular or any other exhaust port circumscribing shape. Instead of machining the annular groove 56, the annular groove is formed by moving material, e.g. using a press in a manner that will be described in more detail below. As more clearly seen in FIGS. 6 and 7, moving the material to form the annular groove 56 (FIG. 5) results in an annular protrusion 58 being formed on an opposite side of the flange 50. As more clearly seen in FIG. 7, the annular protrusion extends axially (with reference to the center of the central opening 52) from a first surface 62 of the flange 50. Accordingly, the groove 56 (FIG. 5) is formed to extend axially inwardly from a second surface 64 which is opposite the first surface 62. If desired, removing the protrusion 58 through machining would most likely be faster than machining an annular groove.

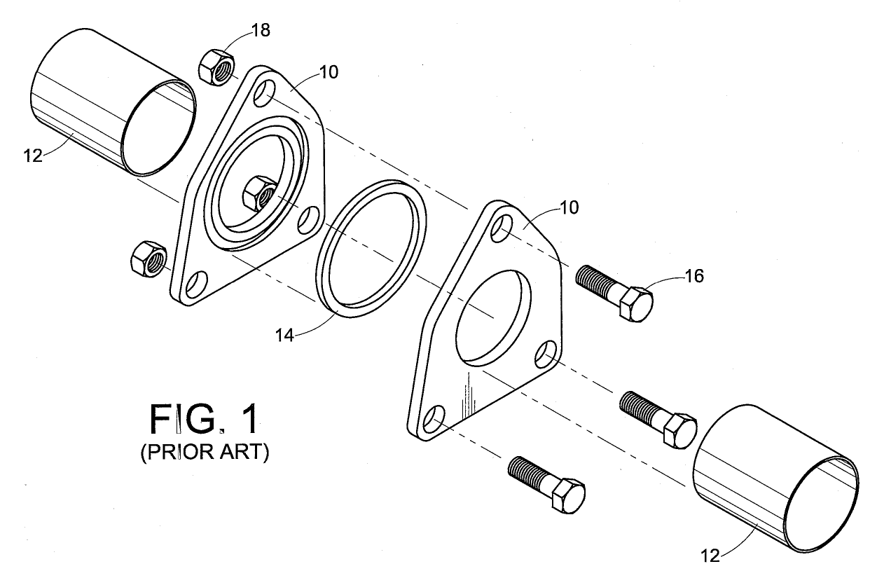

The central opening 52 receives an exhaust pipe (similar to the exhaust pipes 12 depicted in FIG. 1). The second surface 64 of the flange 50 typically abuts another component, e.g. another flange, a catalytic converter or a muffler assembly, when used as an attachment mechanism for an exhaust pipe and the second surface 62, i.e. the surface having the protrusion extending from it, typically does not abut anything. Accordingly, the protrusion 58 does not affect the performance of the flange 50; however, such a construction allows for the economical manufacture of the flange.

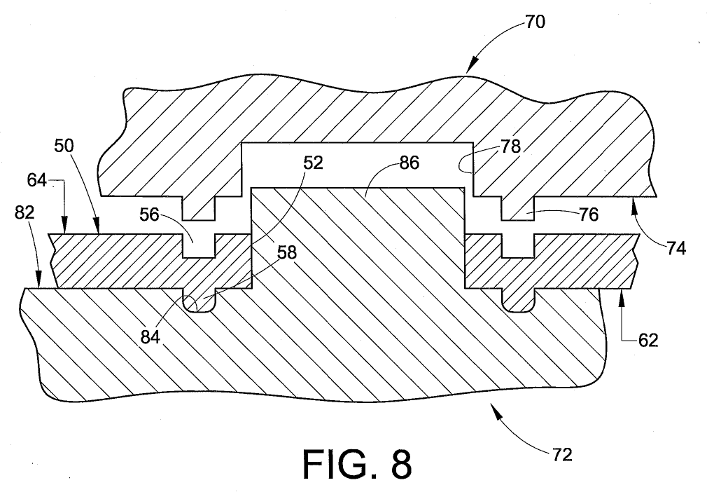

With reference to FIG. 8, the manufacture of the flange 50 will be described in more detail. Generally, a part is formed that includes a central opening 52 and the bolt holes 54 (FIGS. 5 and 6) in much the same manner that was described above for the known flange 10. Instead of machining out an annular groove, the groove 56 is cold formed into the flange 50. To perform this operation, a first (upper) punch 70 (FIG. 8) acts on the second surface 64 of the flange and a second (bottom) punch 72 acts on the first surface 62 of the flange 50. The upper punch 70 generally includes a planar contact surface 74; however, it can also be made without this planar surface. An annular ring 76 extends downwardly from the contact surface 74. The annular ring 76 is dimensioned to form the annular groove 56 in the flange 50. Accordingly, the dimensions of the annular ring 76 can change to accommodate the manufacture of differently dimensioned and shaped annular grooves. A central cavity 78 extends upwardly (per the orientation of FIG. 8) from the contact surface 74.

The bottom punch 72 also includes a contact surface 82. An annular channel 84 extends downwardly (per the orientation of FIG. 8) from the contact surface 82. The annular channel 84 is dimensioned to receive the material that is moved in the part, i.e. the unfinished flange, to allow for the formation of the annular groove 56. In other words, the annular channel 84 in the bottom punch 72 is configured to receive the annular protrusion 58. The bottom punch 72 also includes a central circular protrusion 86, e.g. guide pilot pin, that extends upwardly from the contact surface. The diameter of the central protrusion 86 is approximately equal and slightly smaller than the central opening 52 of the flange to be formed by the punches 70 and 72.

The central protrusion 86 of the bottom punch 72 can be disconnected from the remainder of the bottom punch and be replaced by a differently shaped protrusion to allow for changes in the diameter and shape of the central opening 52 of the flange that is to be received in the punches 70 and 72. Accordingly, the dimensions of the central protrusion 86 of the bottom punch 72 can change to accommodate a flange having a differently dimensioned central opening 52. The central cavity 78 in the upper punch 70 receives the central protrusion 86; therefore, the upper punch may change where a differently shaped flange is desired.

To manufacture the flange 50, the part that will become the flange is placed on the bottom punch 72 with the central protrusion 86 being received inside the central opening 52. The part is supported on the contact surface at a location disposed radially between the central protrusion 86 and the annular channel 84 and radially outward of the annular channel. The upper punch 70 is brought towards the flange 50 and the bottom punch 72 in a manner to move material to form the annular groove 56 and the annular protrusion 58.

Since the bottom punch 72 is configured to allow for the movement of metal from the second surface 64 of the part towards and beyond the first surface 62, not as much pressure is required on the upper punch 70 as would be required if the annular protrusion were not allowed to form on the first side 62 of the flange. Since the first side of the flange 62 does not contact another component in the exhaust system, the annular protrusion 58 does not affect the performance of the flange.

After the groove 56 and the protrusion 58 have been formed, the second surface 64 of the flange can be flattened mechanically or ground. Mechanical flattening can occur by providing an upper punch or press having a planar surface to contact at least the entire second surface 64 of the flange 50. A lower punch or press contacts the surface axially outermost of the protrusion 58. Accordingly, the second surface 64 of the flange 50 is flattened while only an outermost surface of the protrusion 58 is flattened. Typically, this outermost surface is where the bolt holes 54 reside.

Moving material to form the annular groove, as opposed to machining the annular groove 58, greatly increases the efficiency of the mass production of flanges 50. Also, by allowing the protrusion 58 to be formed in the flange 50, the pressure that is to be exerted on the flange to form the annular groove 56 need not be as great as if the protrusion were not allowed to form. Allowing the protrusion to form allows for a lighter duty press.

A flange and method of manufacturing a flange have been described so that one skilled in the art can make and use the flange. The flange can be produced quickly and inexpensively. Alternative embodiments may occur upon reading and understanding the detailed description. Moreover, directional terms have been provided for ease of understanding the figures only. The invention is not limited to only those embodiments and methods described. Instead, the invention is broadly defined by the appended claims.

What is claimed is:

1. A method for manufacturing a flange for a vehicle exhaust system, the method comprising:
cutting a plurality of bolt holes through a blank metal part, the blank part having a first surface, a second surface opposite the first surface and a peripheral edge;
piercing a central opening through the part, the central opening being spaced inwardly of the bolt holes with respect to the peripheral edge of the part; and
displacing metal from the first surface of the part towards the second surface of the part to form an annular groove that is radially spaced between the plurality of bolt holes and the central opening, the material that is displaced to form the annular groove protruding from the second surface of the part to form an annular protrusion.

2. The method of claim 1, further comprising flattening the first surface of the part.

3. The method of claim 2, further comprising flattening only a portion of the second surface of the part.

4. The method of claim 3, wherein flattening only a portion of the second surface further comprises flattening the portion of the second surface located outside of the central opening.

5. The method of claim 3, wherein the displacing metal step further comprises forming the annular groove to extend into the part from the first surface a distance D1 and forming the annular protrusion to extend from the second surface of the part a distance D2, wherein D1 is about equal to D2.

6. The method of claim 5, wherein prior to the displacing metal step the part has a mass M1 and after the displacing metal step the part has the same mass M1.

7. The method of claim 6, wherein the central opening and the annular groove are concentric.

8. The method of claim 1, further comprising removing the protrusion from the second surface.

9. A method for manufacturing a flange for a vehicle exhaust system, the method comprising:
providing an opening in a part, the opening being dimensioned to receive an exhaust pipe of an exhaust system;
providing a plurality of bolt holes in the part, the bolt holes being radially spaced from a periphery of the opening;
moving an annular ring into a first surface of the part, the annular ring contacting the part circumscribing the opening;
supporting a portion of a second surface of the part with a support surface having an annular channel formed in the support surface, the annular channel being generally aligned with the annular ring as the annular ring moves into the first surface to allow material from the part to move into the annular channel as the annular ring moves into the part.

10. The method of claim 9, wherein supporting a portion of the second surface further includes supporting the portion of the second surface on a portion of the support surface located radially inward from the annular channel.

11. The method of claim 10, wherein supporting a portion of the second surface further includes supporting the portion of the second surface on a portion of the support surface located radially outward from the annular channel.

12. The method of claim 9, wherein moving the annular ring comprises moving the annular ring in a vertical direction.

13. The method of claim 9, further comprising placing the part against the support surface and inserting a protrusion extending upwardly from the support surface into the opening of the part.

14. The method of claim 13, wherein the protrusion has a diameter that is slightly smaller than a diameter of the opening.

15. The method of claim 14, wherein the annular ring extends from a contact surface and the contact surface includes a central cavity, wherein the moving step further comprises moving the contact surface towards the part such that the central cavity receives the protrusion.

16. The method of claim 15, wherein the annular ring has a radial cross-sectional dimension W1 and the annular channel has a radial cross-sectional dimension W2, wherein W1<W2.

18. The method of claim 9, further comprising removing an annular protrusion formed in a second surface of the part.

19. The method of claim 9, further comprising flattening the first surface of the part after moving the annular ring into the first surface of the part.

20. In a method of manufacturing a flange for a vehicle exhaust system, the flange comprising a first surface, a second surface opposite the first surface, a peripheral edge, a central opening through the flange from the first surface to the second surface, a plurality of bolts holes radially spaced outwardly from a periphery of the central opening and an annular groove formed in the first surface circumscribing the central opening, the groove being radially spaced outwardly from a periphery of the central opening, the improvement comprising:
forming the annular groove in the first surface of the flange without removing material from the flange.
